(19) United States
(12) Patent Application Publication
(10) Pub. No.: US 2012/0284999 A1
(43) Pub. Date: Nov. 15, 2012

(54) Method for Mounting a Ranging Arm on a Body of a Longwall Shearer Loader

(75) Inventors: Ryszard Bednarz, Katowice (PL); Pawel Gwiazdzinski, Zernica (PL); Lukasz Gonsior, Marklowice (PL); Marek Olszanski, Sosnowiec (PL)

(73) Assignees: FAMUR INSTITUTE SP. Z O.O., Katowice (PL); FAMUR SPOLKA AKCYJNA, Katowice (PL)

(21) Appl. No.: 13/509,260

(22) PCT Filed: Nov. 2, 2010
(86) PCT No.: PCT/PL10/00109

§ 371 Date: Jul. 30, 2012

(30) Foreign Application Priority Data
Nov. 10, 2009 (PL) P389529

(51) Int. Cl. B23P 11/00

(52) U.S. Cl. 29/525.08

(57) ABSTRACT

The method for mounting a ranging arm on a body of a longwall shearer loader characterised by the fact that the shearer's ranging arm (7) is pivotally connected through the eyes (9) and at least one pin (3) with the eyes of the articulated joint (6) located from the side wall side in the bottom part of the shearer's body (5) outside of the chain conveyor (11). The axis of the pin or pins (3) is situated below the axis of the motor (12) of the shearer's ranging arm (7). The hydraulic cylinder (4) is pivotally connected with the eyes (8) of the shearer's ranging arm (7) located between the eyes of the articulated joint (6) with a pin (2), the axis of which is situated above the axis of the motor (12) of the shearer's arm (7). The hydraulic cylinder (4) is pivotally connected with the shearer's body (5) with a pin (1), the axis of which is situated below the axis of the motor (12) of the shearer's arm (7) and below the axis of the feed drive shaft (10). The axis of the pin (1) is situated at the same height as the axis of the pin or pins (3) connecting the shearer's arm (7) with the eyes of the articulated join (6). The hydraulic cylinder (4) is located between the axis of the feed drive shaft (10) and the pin of pins (3) connecting the shearer's ranging arm (7) with the eyes of the articulated joint (6).

The subject of the invention is the method for mounting a ranging arm on a body of a longwall shearer loader.

A shearer's ranging arm mechanism has been described in the Polish description of the utility model No. 41640. The mechanism includes a rocker arm in form of a beam with bent ends, whereas the bent end from the side of a hydraulic cylinder has a tip pointing to the outside and parallel to the main central part of the rocker arm. Such a rocker arm is mounted in the area above the travel in such a manner as to locate it next to the body and parallel to it.

A cutter-loader ranging arm mechanism has also been described in the Polish description of the patent No. 199858. In the case of such a mechanism, a guide is mounted on a cutter-loader body from the bottom side, which is open from both the cylinder side as well as the arm side. The guide is closed from below with a detachable cover. Inside the guide, there is a pilot installed in such a manner as to enable its slide motion. The pilot moves along interchangeable (detachable) glide bars mounted on the guide. On the one side, the pilot is connected through a self-aligning bearing with a piston rod of a hydraulic cylinder of which is also fixed through a self-aligning bearing to the shearer's body. On the other side, the pilot is connected with the eye of the shearer's ranging arm through a rocker. The rocker is connected with the pilot and the eye of the shearer's ranging arm also through self-aligning bearings.

The method for mounting a ranging arm on a body of a longwall shearer loader in line with the invention is characterised by the fact that the shearer's ranging arm is pivotally connected through the eyes and at least one pin with the eyes of the articulated joint located from the side wall side in the bottom part of the shearer body outside of the chain conveyor.

The axis of the pin or the pins connecting the shearer's ranging arm with the eyes of the articulated joint is situated below the axis of the motor of the shearer's arm. The hydraulic cylinder is pivotally connected with the eyes of the shearer's ranging arm located between the eyes of the articulated joint with a pin, whose axis is situated above the axis of the engine of the shearer's arm.

The hydraulic cylinder is pivotally connected with the shearer's body with a pin, whose axis is situated below the axis of the engine of the shearer's arm and below the axis of the feed drive shaft. The axis of the pin is situated at the same height as the axis of the pin or pins connecting the shearer's ranging arm with the eyes of the articulated joint.

The hydraulic cylinder is located between the axis of the feed drive shaft and the pin or pins connecting the shearer's ranging arm with the eyes of the articulated joint.

The method for mounting a ranging arm on a body of a longwall shearer loader described as the invention is intended for use in the case of very low shearers. This method enables easy drive transmission to the caving side in restricted space (overall dimensions) conditions.

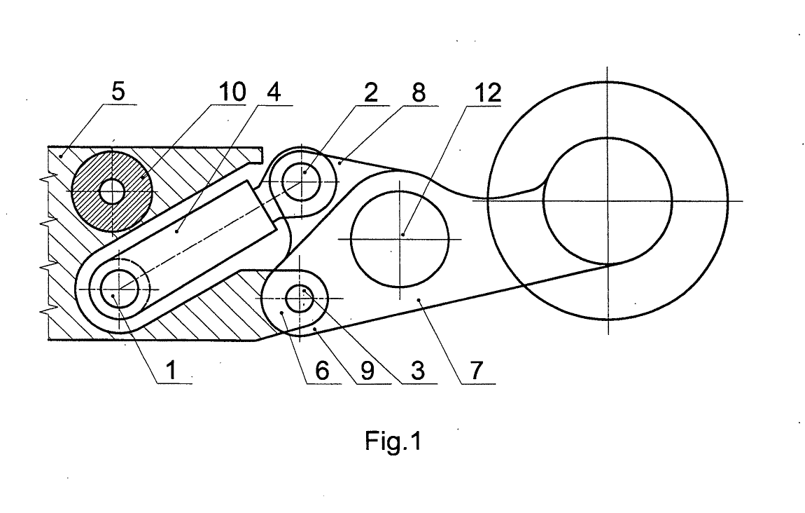

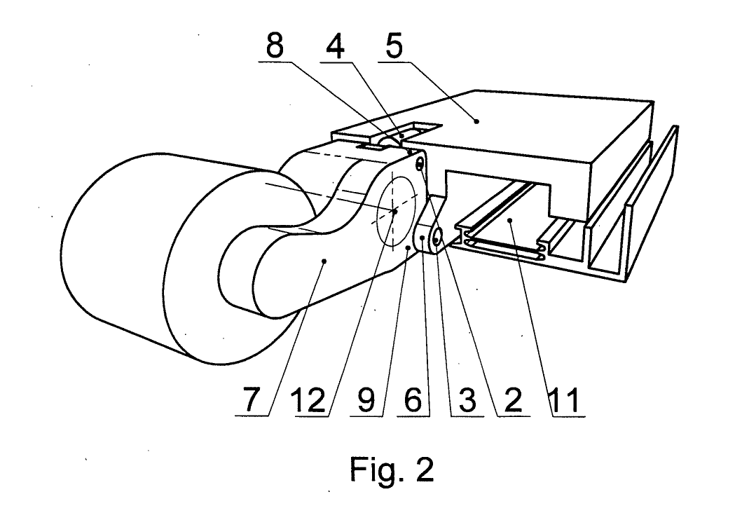

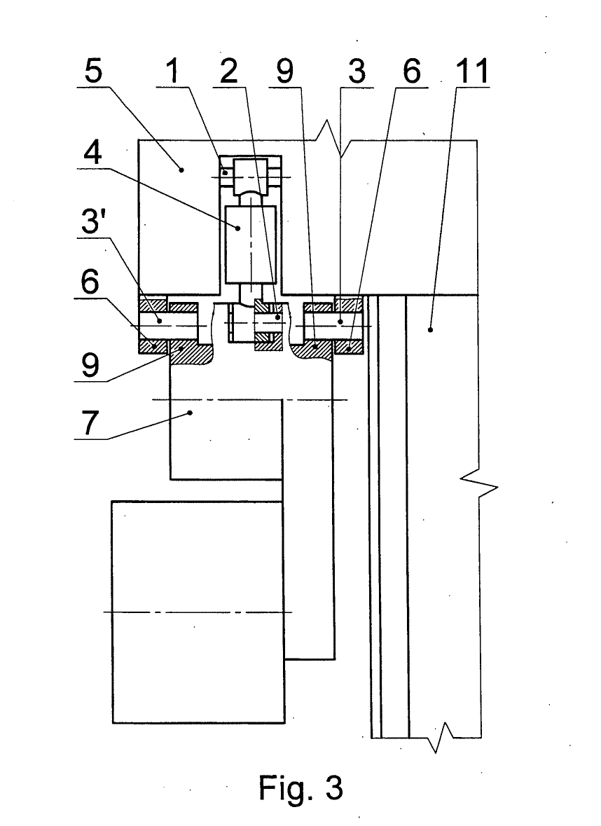

An example of the subject of the invention has been presented in the drawing, where FIG. 1 indicates the method for mounting a ranging arm on a body of a longwall shearer loader as seen from the side, FIG. 2 indicates the method for mounting a ranging arm on a body of a longwall shearer loader as seen in an axonometric view and FIG. 3 indicates the method for mounting a ranging arm on a body of a longwall shearer loader as seen from above.

The shearer's ranging arm 7 is pivotally connected through the eyes 9 and at least one pin 3 with the eyes of the articulated joint 6 located from the side wall side in the bottom part of the shearer's body 5 outside of the armoured face conveyor 11.

The axis of the pin or pins 3 connecting the shearer's ranging arm 7 with the eyes of the articulated joint 6 is situated below the axis of the motor 12 of the shearer's arm 7. The hydraulic cylinder 4 is pivotally connected with the eyes 8 of the shearer's ranging arm 7 located between the eyes of the articulated joint 6 with a pin 2, the axis of which is situated above the axis of the motor 12 of the shearer's arm 7.

The hydraulic cylinder 4 is pivotally connected with the shearer's body 5 with a pin 1, the axis of which is situated below the axis of the cylinder 12 of the shearer's arm 7 and below the axis of the feed drive shaft 10. The axis of the pin 1 is situated at the same height as the axis of the pin or pins 3 connecting the shearer's ranging arm 7 with the eyes of the articulated joint 6. The hydraulic cylinder 4 is located between the axis of the feed drive shaft 10 and the pin or pins 3 connecting the shearer's ranging arm 7 with the eyes of the articulated joint 6.

1. The method for mounting a ranging arm on a body of a longwall shearer loader using an articulated joint and a hydraulic cylinder characterised by the fact that the shearer's ranging arm (7) is pivotally connected through the eyes (9) and at least one pin (3) with the eyes of the articulated joint (6) located from the side wall side in the bottom part of the shearer's body (5) outside of the armoured face conveyor (11), where the axis of the pin or pins (3) connecting the ranging arm (7) of the shearer with the eyes of the articulated joint (6) is situated below the axis of the motor (12) of the shearer's ranging arm (7).

2. The method for mounting a ranging arm on a body of a longwall shearer loader in line with the claim No. 1 characterised by the fact that the hydraulic cylinder (4) is pivotally connected with the eyes (8) of the ranging arm (7) of the shearer located between the eyes of the articulated joint (6) with a pin (2), the axis of which is situated above the axis of the motor (12) of the shearer's ranging arm (7).

3. The method for mounting a ranging arm on a body of a longwall shearer loader in line with the claim No. 1 characterised by the fact that the hydraulic cylinder (4) is pivotally connected with the body (5) of the shearer with a pin (1), the axis of which is situated below the axis of the motor (12) of the shearer's ranging arm (7) and below the axis of the feed drive shaft (10), where the axis of the pin (1) is situated at the same height as the axis of the pin or pins (3) connecting the ranging arm (7) of the shearer with the eyes of the articulated joint (6) and the hydraulic cylinder (4) is situated between the axis of the feed drive shaft (10) and the pin or pins (3) connecting the shearer's ranging arm (7) with the eyes of the articulated joint (6).
